(19) United States
(12) Patent Application Publication
(10) Pub. No.: US 2017/0032248 A1
(43) Pub. Date: Feb. 2, 2017

(54) Activity Detection Based On Activity Models

(71) Applicant: Microsoft Technology Licensing, LLC, Redmond, WA (US)

(72) Inventors: Dikla Dotan-Cohen, Herzliya (IL); Ido Priness, Herzliya (IL); Haim Somech, Ramat Gan (IL)

(21) Appl. No.: 14/811,255

(22) Filed: Jul. 28, 2015

(51) Int. Cl. G06N 5/02; H04L 29/08

(52) U.S. Cl. CPC G06N 5/02; H04L 67/22

(57) ABSTRACT

An event tracker detects instances of events of a user and an activity analyzer detects instances of activities of the user based at least in part on sensor data. The activity analyzer identifies candidate activities for each of the instances of the events and detects one or more patterns of user behavior of the user corresponding to a designated activity of the candidate activities from the instances of the events. The activity analyzer further predicts values of semantic characteristics of the designated activity from the one or more patterns of user behavior. Further, the activity analyzer identifies an instance of the designated activity as a practiced activity using the predicted values of the semantic characteristics and actual values of the semantic characteristics of the instance of the designated activity in an activity model that represents the designated activity. Personalized content is provided to the user based on the identified practiced activity.

### BACKGROUND

Computerized personal-assistant applications and services can provide user experiences that are personalized to a user based on locations frequently visited by the user. These experiences may be made available via mobile devices, such as smart phones, because these devices are capable of providing accurate location information for the user. For example, if the GPS sensor of a user's smart phone detects that the user is at a location associated with the user's home, then a personal assistant application may withhold work-related notifications from the user's computing devices until the GPS sensor detects that the user is at a location corresponding to the user's place of work.

When sufficient personalized services are offered to users, their consumption of computing resources is reduced. Insufficient personalized services can have the opposite effect on resource consumption. However, often times personalized services lack the data points required to reliably provide sufficient personalized services to users. In these cases, the systems may refrain from providing personalized services as an alternative to providing insufficient personalized services. In either scenario, users may consume extensive computing resources of their devices and of content providers (e.g., network bandwidth, battery life, power, storage bandwidth, etc.) searching for, downloading, and/or evaluating content attempting to perform tasks that could be eliminated by sufficient personalized services.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Aspects of the present disclosure relate to detecting activities of users based on activity models. In some implementations, an event tracker detects instances of events of a user and an activity analyzer detects instances of activities of the user based at least in part on sensor data. The activity analyzer identifies candidate activities for each of the instances of the events and detects one or more patterns of user behavior of the user corresponding to a designated activity of the candidate activities from the instances of the events. The activity analyzer further predicts values of semantic characteristics of the designated activity from the one or more patterns of user behavior. Further, the activity analyzer identifies an instance of the designated activity as a practiced activity using the predicted values of the semantic characteristics and actual values of the semantic characteristics of the instance of the designated activity in an activity model that represents the designated activity. Personalized content may be provided to the user based on the identified practiced activity.

In further respects, the instance of the designated activity can correspond to a respective instance of an event, or may be a multi-event activity extracted from multiple-historical events. In some cases, the instance of the designated activity is a contemporary activity and the actual values of the semantic characteristics are real-time values of the semantic characteristics. In other cases, the actual values of the semantic characteristics can be non-real-time values of the semantic characteristics and the instance of the designated activity can correspond to a particular historical instance of an event. These and other concepts are contemplated as being within the scope of the present disclosure.

### BRIEF DESCRIPTION OF THE DRAWINGS

The present invention is described in detail below with reference to the attached drawing figures, wherein:

FIG. 1 is a block diagram showing an exemplary operating environment in accordance with implementations of the present disclosure;

FIG. 2 is a block diagram showing an exemplary system in accordance with implementations of the present disclosure;

FIG. 3 depicts exemplary diagram illustrating functionality of an activity analyzer;

FIG. 4 is a flow diagram showing a method for detecting activities of users in accordance with implementations of the present disclosure;

FIG. 5 is a flow diagram showing a method for detecting activities of users in accordance with implementations of the present disclosure;

FIG. 6 is a flow diagram showing a method for detecting activities of users in accordance with implementations of the present disclosure; and

FIG. 7 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present disclosure relate to detecting activities of users based on activity models. In some implementations, an event tracker detects instances of events of a user and an activity analyzer detects instances of activities of the user based at least in part on sensor data. The activity analyzer identifies candidate activities for each of the instances of the events and detects one or more patterns of user behavior of the user corresponding to a designated activity of the candidate activities from the instances of the events. The activity analyzer further predicts values of semantic characteristics of the designated activity from the one or more patterns of user behavior. Further, the activity analyzer identifies an instance of the designated activity as a practiced activity using the predicted values of the semantic characteristics and actual values of the semantic characteristics of the instance of the designated activity in an activity model that represents the designated activity. Personalized content may be provided to the user based on the identified practiced activity.

In further respects, the instance of the designated activity can correspond to a respective instance of an event, or may be a multi-event activity extracted from multiple-historical events. In some cases, the instance of the designated activity is a contemporary activity and the actual values of the semantic characteristics are real-time values of the semantic characteristics. In other cases, the actual values of the semantic characteristics can be non-real-time values of the semantic characteristics and the instance of the designated activity can correspond to a particular historical instance of an event. These and other concepts are contemplated as being within the scope of the present disclosure.

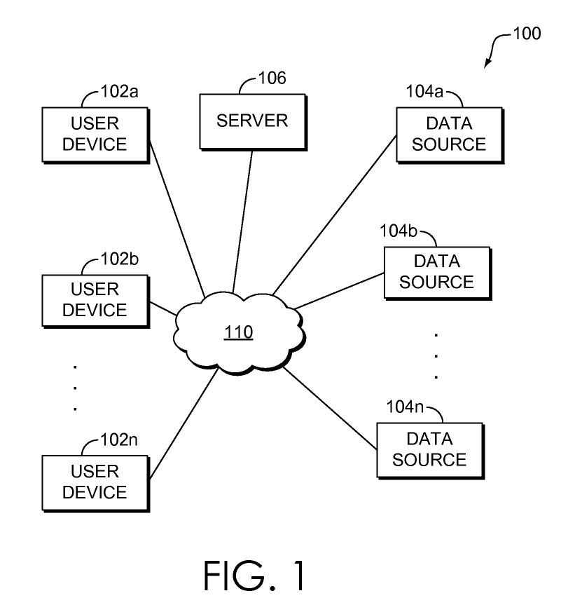

Turning now to FIG. 1, a block diagram is provided showing an example operating environment 100 in which some implementations of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

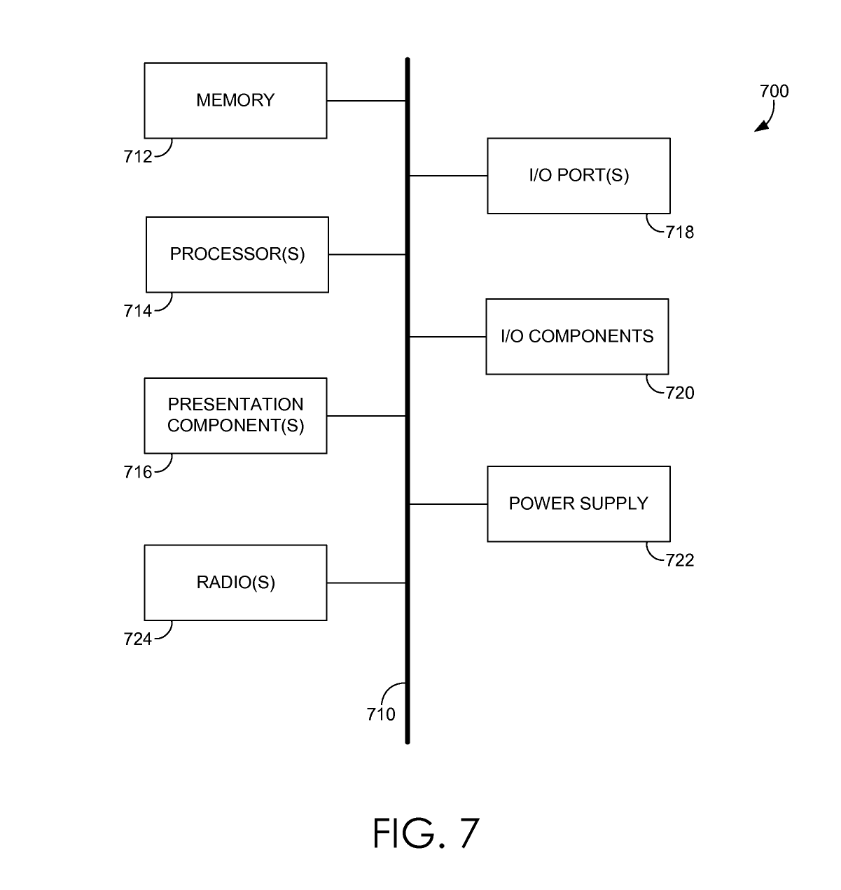

Among other components not shown, example operating environment 100 includes a number of user devices, such as user devices 102a and 102b through 102n; a number of data sources, such as data sources 104a and 104b through 104n; server 106; and network 110. It should be understood that operating environment 100 shown in FIG. 1 is an example of one suitable operating environment. Each of the components shown in FIG. 1 may be implemented via any type of computing device, such as computing device 700, described in connection to FIG. 7, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a through 102n can be client devices on the client-side of operating environment 100, while server 106 can be on the server-side of operating environment 100. Server 106 can comprise server-side software designed to work in conjunction with client-side software on user devices 102a through 102n so as to implement any combination of the features and functionalities discussed in the present disclosure. This division of operating environment 100 is provided to illustrate one example of a suitable environment, and there is no requirement for each implementation that any combination of server 106 and user devices 102a through 102n remain as separate entities.

User devices 102a through 102n may comprise any type of computing device capable of being operated by a user. For example, in one implementation, user devices 102a through 102n may be the type of computing device described in relation to FIG. 7 herein. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

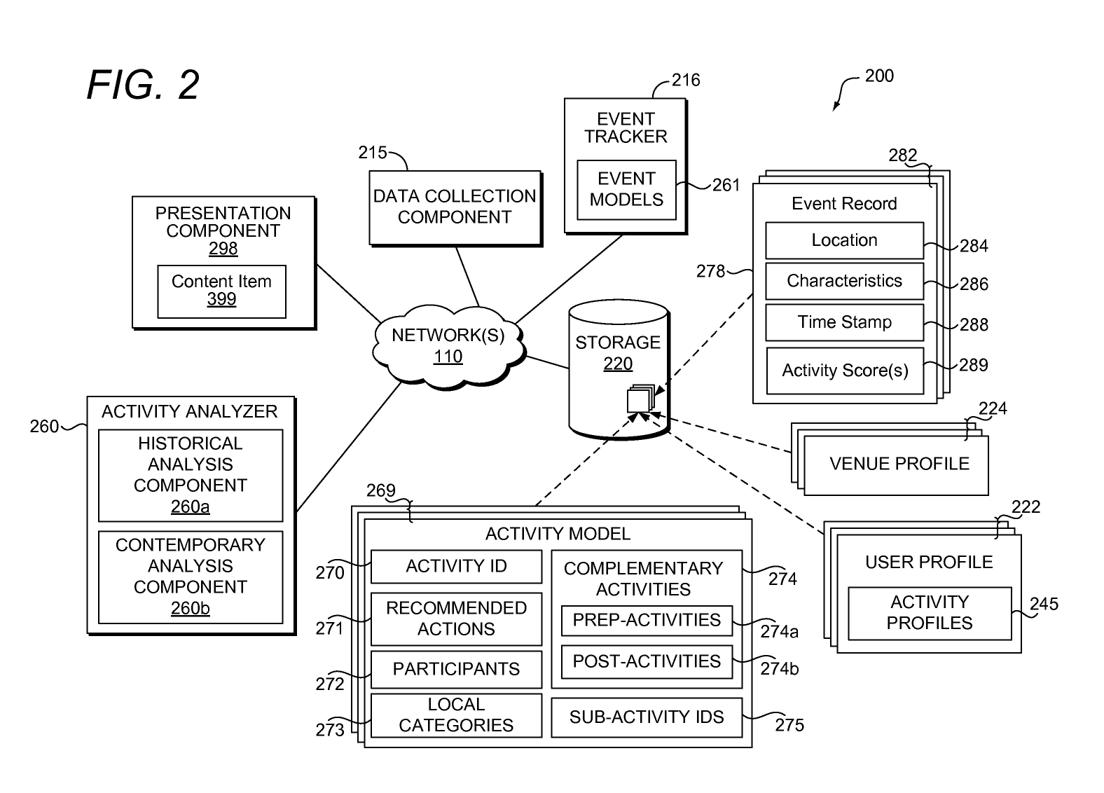

Data sources 104a and 104b through 104n may comprise data sources and/or data systems, which are configured to make data available to any of the various constituents of operating environment 100, or system 200 described in connection to FIG. 2. (For example, in one implementation, one or more data sources 104a through 104n provide (or make available for accessing) user data to data collection component 215 of FIG. 2.) Data sources 104a and 104b through 104n may be discrete from user devices 102a through 102n and server 106 or may be incorporated and/or integrated into at least one of those components. In one implementation, one or more of data sources 104a though 104n comprises one or more sensors, which may be integrated into or associated with one or more of the user device(s) 102a through 102n or server 106. Examples of sensed user data made available by data sources 104a though 104n are described further in connection to data collection component 215 of FIG. 2.

Operating environment 100 can be utilized in conjunction with the components of the exemplary computing system architecture depicted in FIG. 2 that is suitable for implementing embodiments of the invention and is generally designated as system 200. System 200 represents only one exemplary computing system architecture suitable for implementing aspects of the invention. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location. Among other components not shown, system 200 is generally comprised of components for inferring activities, based on event records (e.g., event records 282) of events. System 200 includes such components as data collection component 215, storage 220, event tracker 216, activity analyzer 260, and presentation component 298, all of which are communicatively coupled via network 110.

In some implementations, the functions performed by components of system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some implementations these components of system 200 may be distributed across a network, including one or more servers (such as server 106) and client devices (such as user device 102a), in the cloud, or may reside on a user device such as user device 102a. As with operating environment 100, some of the components described herein may be embodied as a set of compiled computer instructions, computer functions, program modules, computer software services, or an arrangement of processes carried out on one or more computer systems, such as computing device 700 described in connection to FIG. 7.

These components, functions performed by these components, or services carried out by these components may be implemented at appropriate abstraction layer(s) such as the operating system layer, application layer, hardware layer, etc., of the computing system(s). Alternatively, or in addition, the functionality of these components and/or the implementations of the invention described herein can be performed, at least in part, by one or more hardware logic components. Exemplary types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in exemplary system 200, it is contemplated that in some implementations functionality of these components can be shared or distributed across other components.

In general, storage 220 is configured to store computer instructions (e.g., software program instructions, routines, or services), data, and/or models used in implementations of the embodiments described herein. In some implementations, storage 220 stores information or data received via the various components of system 200 and provides the various components of system 200 with access to that information or data. For example, storage 220 may store such information or data as user, event, venue, and interpretive data described with respect to data collection component 215, interaction data, inferential data, semantic information, semantic characteristics, interaction datasets, crowd-sourced datasets, individual-sourced datasets, user routine models, routine-related inferences, routine-related profiles, user profiles (e.g., user profiles 222), venue profiles (e.g., venue profiles 224), event models (e.g., 261), activity models (e.g., activity models 269), and event records (e.g., event records 282). In implementations, storage 220 comprises a data store (or computer data memory). Although depicted as a single component, storage 220 may be embodied as one or more data stores or may be in the cloud. Further, the information in storage 220 may be distributed in any suitable manner across data stores for storage.

Data collection component 215 is generally responsible for acquiring, accessing, or receiving (and in some cases also identifying) user data, venue data, and interpretive data from one or more data sources, such as data sources 104a through 104n of FIG. 1. User data corresponds to data acquired in association with one or more users. As used herein, a user can correspond to a user profile, such as one of user profiles 222, which optionally may be associated with a user account comprising one or more of a username, a password, a user device (e.g., a media access control address), an Internet Protocol (IP) address, a universally unique identifier (UUID), and/or other user identifiers. In some cases, user data may not be directly associated with a user account, but may be associated with another user account that is known or designated to correspond to the same user. For example, one of user profiles 222 may be linked to one or more other user accounts, which may be in another system or other systems. As examples, the same user could have a Microsoft® account, an Amazon.com® account, a Facebook® account, a PayPal® account, a Google® Account, a Twitter® account, a bank account, an eBay® account, and an XBOX Live® account, each of which may be associated with user data of the user, and semantic information may be extracted therefrom.

Venue data corresponds to data collected in association with one or more venues. A “venue” may refer to a physical location that people can conduct certain activities at in person. Examples of a venue include, but are not limited to a particular: store, restaurant, theater, sport arena, factory, and office building. As used herein, a venue can correspond to a venue profile, such as one of venue profiles 224, which may be associated with a corresponding venue identifier (ID) and optionally various semantic characteristics (routine characteristics and/or sporadic characteristics) of the venue including a name of the venue, a category of the venue, a location or region of the venue, and the like.

Examples of semantic characteristics that may be utilized to infer event and/or activity instances include routine characteristics of a user and/or location (e.g., a geographic areas or venue). A routine characteristic corresponds to a semantic characteristic that is routine, common place, or regular for the location or user. Routine characteristics may optionally be inferred using event tracker 216 and/or activity analyzer 260 (e.g., this user often eats fast food or users in this location often eat fast food, or it typically rains in this location). A sporadic characteristic can correspond to a characteristic of a location or a user that is irregular, occasional, or isolated for a location or a user.

Whether a characteristic is a routine characteristic or a sporadic characteristic may depend on the perspective, understanding, and knowledge of the system. For example, routine characteristics and sporadic characteristic can both be types of inferred characteristics that are discovered by the system. A routine characteristic can be a characteristic that is determined by the system as being part of a routine model that is detected and tracked by the system (e.g., venue visits, visitation patterns, activity patterns, and/or behavior patterns, or routines). A sporadic characteristic can be a characteristic that is determined by the system, but not as being part of a known routine practiced by a location or user that is detected and tracked by the system (e.g., an event that is not part of a known practiced routine vs. an event that may or may not be part of a known practiced routine). In some cases, a sporadic or routine characteristic may be inferred from multiple characteristics, which can include at least one routine characteristic or sporadic characteristic.

Some examples of routine characteristics of a user include user preferences, such as cuisine preferences, brand preferences, movie preferences, music preferences, parental status (i.e., whether the user is a parent), demographic information (e.g., age, gender, marital status, the user being engaged to be married, the user being married, the user being single, literacy/education, employment status, occupation, residence location), routinely visited venues (e.g., user hubs), the user repeatedly performing an activity or event on a particular data of the week, or at a particular time of day, and many more. Examples of sporadic characteristics of a user include the user being sick, the user craving fast food, the user being late for work, the user diverging from or contradicting an expected tracked routine, the user being on vacation, specific personal events of the user, such as a wedding, and many more.

Examples of routine characteristics of a location (e.g., a venue) include a type, utility, or merchant category (e.g., restaurant, retail, coffee shop, gym, movie theater, entertainment, work, office, etc.), a particular venue chain category, such as a Starbucks®, or a Walmart®, cuisine served in the location, operating hours of a venue corresponding to the location, peak visit times to the location, aggregate receipt totals for visitors at a location, regular sales or other events at a location (e.g., annual sales), aggregate visitor demographics, aggregate visitor characteristics, and many more. Examples of sporadic characteristics include a specific concert occurring on a particular day or at a particular time at a location, an unexpected spike in visitors to a location and/or visitors or traffic (e.g., people or vehicles) near a location, current weather conditions at a location, unusual events or activity occurring at a location, and many more.

Interpretive data corresponds to data utilized to supplement the interpretation of information in system 200. In this regard, any of the various components in system 200 can use the interpretive data to support inferences based on the information available to system 200, such as semantic characteristics and interaction data. Interpretive data can be used by any of the various components of system 200 to provide context to the information to support the inferences made in system 200. As an example, interaction data (e.g., user data) could indicate that a user was at a location, whereas interpretative data can comprise weather information utilized to infer that the user was not at a baseball stadium at the location due to a snowstorm. The types of inferences are applicable throughout the present application.

The data acquired by data collection component 215, including user data, venue data, and interpretative data, can be collected by data collection component 215 from a variety of sources in which the data may be available in a variety of formats. Examples of user or venue data include data derived from one or more sensors which may correspond to any of data sources 104a through 104n of FIG. 1. As used herein, a sensor may include a function, routine, component, or combination thereof for sensing, detecting, or otherwise obtaining information such as user data or venue from data, and may be embodied as hardware, software, or both. By way of example and not limitation, the user or venue data may include data that is sensed or determined from one or more sensors (referred to herein as “sensor data”), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user-data associated with communication events; etc.) including user activity that occurs over more than one user device, user history, session logs, application data, contacts data, calendar and schedule data, notification data, social-network data, news (including popular or trending items on search engines or social networks), online gaming data, ecommerce activity (including data from online accounts such as a Microsoft account, Amazon.com, eBay, PayPal, or Xbox Live), user-account(s) data (which may include data from user preferences or settings associated with a personal assistant application or service), home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein.

In some respects, at least some of the data may be provided as input signals to the various components of system 200. An input signal can correspond to a feed of data from a corresponding source or sensor, such as any of the various sources or sensors described above. A user signal may refer to an input signal that comprises a feed of user or venue data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. Similarly, a venue signal may refer to a feed of venue data from a corresponding data source. For example, a venue signal could be from a thermometer, a Rich Site Summary (RSS) document, a Twitter user, a barometer, a venue website, or other data sources.

In some aspects of the present disclosure, the user data includes interaction data, which may be received from a plurality of user devices (such as user devices 102a through 102n of FIG. 1) associated with a user or in some instances, associated with multiple users. In this way, user activity of a particular user from multiple user devices used by the user (e.g. the user's mobile phone, laptop, tablet, etc.), may be received as interaction data. Interaction data may be received, acquired, or accessed, and optionally accumulated, reformatted and/or combined, by data collection component 215 and stored in one or more data stores such as storage 220. For example, at least some interaction data may be stored in or associated with one of user profiles 222, as described herein. The one or more data stores may thus be made available to activity analyzer 260, event tracker 216, and presentation component 298.

In some implementations, data collection component 215 is configured to accumulate interaction data reflecting user activity detected by one or more sensors for an individual user (“individual-sourced interaction data”). In some implementations, data collection component 215 is configured to accumulate interaction data associated with user-source interactions for a plurality of users (“crowd-sourced interaction data”). Any personally identifying data (i.e., interaction data that specifically identifies particular users) may either not be uploaded from the one or more data sources with interaction data, may not be permanently stored, and/or may not be made available to activity analyzer 260, event tracker 216, and/or presentation component 298. At least some of the interaction data may be processed to generate event records 282, described in further detail below.

Interaction data may be received from a variety of sources where the data may be available in a variety of formats. For example, in some implementations, user data accumulated by data collection component 215 is received via one or more sensors associated with user devices (such as user device 102a and/or other devices associated with the user), servers (such as server 106), and/or other computing devices.

The user data, venue data, and interpretive data may be continuously collected over time by a large variety of possible data sources and/or data systems. It is intended that the collection and accumulation of user data and venue data embody robust privacy and data protection for individuals, businesses, and public-sector organizations. In this respect, users, and, in appropriate cases venues, are given control over many aspects related to associated data, including the ability to opt in or opt out of data collection and/or any of the various tracking or analysis features described herein. Furthermore, safeguards are to be implemented to protect sensitive data from access by other parties, including other users, without express consent of the user or account administrator. Additionally, any data that is collected is intended to be made anonymous, whenever possible.

In addition to acquiring the data from the data sources, data collection component 215 can extract semantic information such as explicit and/or inferred semantic characteristics of users, geographic tiles, and/or venues from any combination of user data, venue data, or other data that may be included in the acquired data. Extracted semantic characteristics of users may be stored in association with one or more user profiles, such as user profiles 222. Further, extracted semantic characteristics of venues, may be stored in association with one or more venue profiles, such as venue profiles 224. Extracted semantic characteristics of activities and/or events may be stored in association with one or more activity profiles of activity models 269, such as in an event record or elsewhere.

Explicit semantic characteristics correspond to explicit information, which may be explicit from a user, or explicit from a data source (e.g., a web page, document, file, yellow pages, maps, indexes, etc.) from which the information is extracted. As an example, explicit information can be extracted from data recording input by a user of likes and dislikes into a user profile associated with one of user profiles 222. As another example, the data could record a like from a “like button” on a social media site, which is provided to system 200. As another example, the explicit information could comprise a venue name and/or category extracted from yellow pages.

Deeper understandings of users, venues, and activities are available to system 200 by extracting inferred semantic characteristics. Inferred semantic characteristics can be discovered by the system by making inferences from any of the information available to system 200. This includes any combination of the user and venue data, as well as previously extracted explicit and/or inferred semantic characteristics of one or more users (e.g., the user), venues, and/or geographic tiles. In some implementations, inferred semantic characteristics can be updated over time as additional information is available for inferences. For example, the additional information may be used to determine that one or more inferred semantic characteristics no longer apply to one or more users, venues, and/or activities. This may be, for example, a result of changes in the nature of the user, venue, and/or activities and/or a result of system 200 having a better understanding of users, venues, and/or activities or the world based on the additional information. In some cases, inferred semantic characteristics might additionally or instead be updated over time based on the information available to system 200 becoming stale or otherwise unreliable. Where inferred semantic characteristics change, any information based on the semantic characteristics could be updated.

In some cases, event tracker 216 can be utilized to assist in generating inferences by any of the various components in system 200. Event tracker 216 is configured to identify and track events and optionally routines, or patterns, of one or more users, venues, and/or activities from interaction data, such as user and venue data. A “routine,” or routine model, may be defined in terms of one or more recurring events or activities that make up the routine. An “event,” or event model, can correspond to one or more defined actions, behaviors, and/or activities that correspond to a user, venue, or activity, and are detectable from user and/or venue data and tracked by system 200. An event may be under defined conditions, such as a time of day, a day of the week, a location, or other patterns or other detectable behavior associated with a user, such as actions associated with geographic locations, semantics of locations, persons with whom the user is with, weather conditions, and more. Various tracked features may be analyzed by event tracker 216 to determine whether these defined conditions have been met, as will be discussed in further detail below.

Generally, system 200 comprises one or more event models (e.g., probabilistic models), such as event models 261. Examples of user behavior that may be detectable by a corresponding event model include the user driving a car, searching the internet, launching a streaming movie application or service, making a reservation, writing a review, ordering a cab, launching a specific application, riding a bike, eating at a particular restaurant, being in a geographic region, being at a geographic location, attending a meeting, causing a sensor reading from a mobile device, going to the gym, and being at work, launching a service content item, interacting with a service content item, listening to a song or video, downloading a service content item, being at a geographic location, attending a meeting, and/or any combination thereof, amongst many more possibilities. Some events may be location neutral whereas others may be location dependent. In other words, some events may require one or more locations of the user to be detected to have occurred whereas other may not require a detected location. In some cases, an event comprises the user visiting a venue, such as a particular venue, which may be identified and selected by event tracker 216. It is noted that one to all events can be associated with a routine model (e.g., probabilistic models). However, in many cases, an event may not be associated with a routine model.

Event tracker 216 can store any of the various data employed in tracking routines and/or events of users, venues, and/or activities as user tracking data, venue tracking data, and activity tracking data respectively. Over time, event tracker 216 may update the tracking data as data is periodically analyzed and new events, routines, and activities are discovered, modified, or disassociated with users, venues, and/or geographic tiles. One or more semantic characteristics of users, venues, and activities can be inferred from the tracked data. Thus, it will be appreciated that semantic characteristics, such as cuisine preferences, movie watching patterns, and the like may also be updated and discovered for users based on the data. Further, these semantic characteristics may be fed into various components, such as event tracker 216, to support new inferences or update old inferences.

The data acquired by data collection component 215 and processed by event tracker 216 on aggregate forms a detailed record of patterns of instances of events involving users and venues. These patterns can provide understanding and knowledge to system 200 and can be identified and detected by the various components of system 200 including event tracker 216 and presentation component 298. For example, presentation component 298 may employ at least some of these patterns of instances of events (e.g., using event records) in recommending service content items to users (e.g., associated with user profiles 222).

However, the user behavior modeled by events might not be sufficient to truly understand the semantics behind the behavior. For example, users typically perform events for particular purposes, as part of particular activities.

Event models 261 are suitable for detecting particular types of behavior, such as venue visits, web browsing activity, and other occurrences of specific behavior patterns. However, event models 261 might not be suitable for directly detecting particular activities of users from events. For example, representing each activity as an event model for a large number of activities may require extensive numbers of event models with highly specific tracked features and conditions. These event models would typically have large amounts of redundancy and overlap between the tracked features and conditions of the events. As an example, where an event model represents a person visiting a venue, the event may be part of multiple activities simultaneously (e.g., shopping, a family outing, shopping for clothes, shopping for groceries, running errands, etc.). Capturing each of these activities directly from event models would require a separate event and all of the associated processing and storage for each activity.

Furthermore, representing each activity as an event inherently ties the activity to the specific behavior and semantics represented by the event. However, certain types of activates are may not be tied to specific behavior and semantics (e.g., a venue visit based event and web browsing based event could both be considered a shopping activity). It may be desirable to detect these types of activities. Therefore, the number of event models and associated data and processing required to detect the same activity in different contexts would proliferate.

Thus, personalized services offered to users based on events and patterns of events while helpful, may not be as contextual and relevant to the user's activities as desired. In accordance with various implementations of the present disclosure, activity models (e.g., activity models 269) are provided in addition to event models. Each activity model (e.g., probabilistic model) which defines user behavior for the activity including tracked features and conditions or detecting and/or identifying the activity.

In some respects, activity analyzer 260 is configured to analyze and/or detect one or more activities of a user for each instance of an event. Thus, the same instance of an event model can be utilized to detect and identify multiple activities of a user. Further, the same event model can be utilized to detect and identify different sets of activities of a user in different instances of the event. Thus, the underlying base behavior of the event model and its associated storage and processing can be leveraged vastly reducing resource consumption.

Each event models and activity model may be distinguished in terms of the tracked features and/or conditions defined by the model. It should be noted that tracked features may be derived from any of the various types of data described herein, including sensed user data, venue data, and semantic characteristics of users, venues, events, and/or activities, including routine characteristics, sporadic characteristics, inferred characteristics, and/or explicit characteristics. Event tracker 216 analyzes and processes this information as defined by the event model. Furthermore, activity analyzer 260 analyzes and processes this information as defined by the activity model.

An activity model may represent a categorization of a plurality of defined user actions or grouping of user actions (e.g., event models), which may be under defined conditions, such as a time of day, a day of the week, a location, or other patterns or other detectable behavior associated with a user, such as actions associated with geographic locations, semantics of locations, persons with whom the user is with, weather conditions, and more.

Thus, it will be appreciated that in various implementations, an activity instance corresponds to a categorization of one or more instances of events. For example, an instance of an event model based on a user web browsing could correspond to multiple activities, such as shopping, buying movie tickets, reading the news, and/or making a restaurant reservation. As a further example, an instance of an event model based on a user visiting a venue could correspond to multiple activities, such as shopping, watching a movie, picking up a family member, eating dinner, and more.

From the foregoing example it should be apparent that, in some cases, an activity instance may exist independent from specific event models. For example, in each event above the user was performing the activity of shopping, but carrying out the shopping in vastly different ways. By abstracting the activities from events, which may be from different event models and/or instances, patterns in activities may be discovered and leveraged that otherwise lie latent in interaction data. For example, personalized services can be provided to the user based on activities detected from multiple events and optionally patterns formed by those detected activities.

In further respects, activity models may have corresponding activity profiles 245, which identify an activity in association with a user. An activity profile can comprise information that personalizes an activity to the user, such as semantic characteristics of the activity extracted in association with instances of the activities detected and/or identified for the user. The activity profiles provide additional insight into the various patterns formed by the activity instances of the activity model for the user. This information can be leveraged by activity analyzer 260 and event tracker 216, for example, to assist in identifying and/or ranking activities for events (e.g., as they are occurring or after they have occurred) and/or to revise prior identifications and/or rankings of activities for events.

In various implementations, the activity profiles of an activity can be utilized to identify an instance of an activity independent from a particular event. For example, an activity may be identified, at least partially based on one or more inferences determined by evaluating (or analyzing) one or more tracked features derived from currently-sensed interaction data with respect to one or more tracked features of activity profiles.

Thus, the historical semantic characteristics of the activity extracted from multiple instances of the activities for the user can be utilized to identify new instances of the activity. User routine models used to generate semantic characteristics of activities are trained using data associated with previously-sensed interaction data in order to identify new instances of activities. In doing so, activity analyzer 260 can quantify a level of conformance between currently-sensed interaction data and the historic patterns detected from associating activities with events. Thus, this information can be used to provide strong indications or signals of occurrences of activities. The routine signals or characteristics can be included in the features utilized to detect activities along with sporadic signals or characteristics corresponding to a particular instance (e.g., currently-sensed interaction data for online or real-time detection and identification or previously-sensed interaction data for offline or non-real-time detection and identification).

As indicated above, an activity and/or event may have one or more tracked features defined by its corresponding model. Values of one or more of the tracked features may optionally be stored in association with a user, for example, with respect to a corresponding one of user profiles 222 for later use. Tracked features can correspond to any of a variety of user data, examples of which have been described above, and include interaction data, or sensor data or readings, which may be sensed by one or more sensors (such as information associated with a user device regarding location, position, motion/orientation, user-access/touch, connecting/disconnecting a charger, app interaction, user activity on the user device, or other information that may be sensed by one or more sensors, such as sensors found on a mobile device) GPS coordinate samples, and many more.

It will be appreciated that values of tracked features may be associated with one or more events and/or activities and need not be event or activity specific. FIG. 2 shows various examples of tracked features that may be associated with an event or activity. In some cases, the tracking data includes records that may store or otherwise indicate any of the various data associated with a routine, activity, and/or event, such as events of the routine, activities of events, and/or values associated with tracked features of those events or activities. One such example includes event records 282, described in further detail below. However, various separate records may be employed for activities and routines.

As shown, events records 282 are stored in storage 220. Event record 278 corresponds to a respective instance of an event and may be representative of the type of values of tracked features that may be stored for a particular event model, activity model, and/or routine model. The tracked features are variables that are assigned and/or recorded by event tracker 216 and/or activity analyzer 260 with respect to a corresponding detected instance of an event and/or activity. Tracked features can correspond to any of a variety of user data or venue data, examples of which have been described above and include sensor data or readings, which may be sensed by one or more sensors (such as information associated with a user device regarding location, position, motion/orientation, user-access/touch, connecting/disconnecting a charger, user activity on the user device, or other information that may be sensed by one or more sensors, such as sensors found on a mobile device) GPS coordinate samples, and many more.

As shown with respect to event record 278, each record can include any combination of a location (e.g., location 284), semantic characteristics (e.g., semantic characteristics 286), and a time stamp (e.g., time stamp 288), and one or more activity scores (e.g., activity scores 289).

A time stamp (e.g., time stamp 288) of an instance corresponds to the instance of an event model, activity model, and/or routine model and can indicate the relative order or sequence of the instance with respect to other instances of the model, and optionally instances of one or more other models tracked within system 200.

A location (e.g., location 284) of an instance corresponds to the instance of an event model, activity model, and/or routine model and identifies a geographic location associated with the instance of the model (e.g., where the user interaction and/or behavior of the model is detected to occur). The location can comprise any information suitable for system 200 to associate an instance of a model with a designated geographic area or point.

An example of a location is a geo-point (e.g., geo-coordinates) that system 200 can determine is within the geographic area. Another example is an identifier of a geographic area or tile. A further example is a venue ID (e.g., associated with one of venue profiles 224) that system 200 can identify within a geographic area or tile, or at a geographic point. In some implementations, event tracker 216 optionally infers a venue visit by a user in association with an event and generates the location based on the identified venue (or potentially identified candidate venues).

The location for a record can optionally be based at least partially on one or more spatial samples, such as spatial-temporal samples. A spatial-temporal sample can correspond to data that identifies a specific event, activity, routine, user, and/or device at a location at a time. For example, a spatial-temporal sample can include a geographic location and a time stamp corresponding to the geographic location. Event tracker 216 could use the time stamp as the time stamp of a record or could use it to generate that time stamp (e.g., a mean or median of multiple time stamps). The geographic location may include location coordinates, such as a latitude and longitude, and possibly measurement uncertainty information indicative of the accuracy of the geographic location.

Where spatial-temporal samples are provided by a sensor, such as a GPS receiver, the time stamp may be generated by the sensor, for example, at or associated with a time when a location is determined and/or measured by the sensor, along with its GPS coordinates. In some cases, the location data can be extracted from one or more user signals to provide a stream of location data that is aggregated into the location of an event, activity, or routine. This can include using cluster analysis of the spatial-temporal samples and may consider other forms of location data and algorithms to arrive at a location for an event instance record.

While a GPS receiver is described, the location data used for determining the location for a record can be at least partially extracted by data collection component 215 using any of a variety of approaches for determining a location of a user for an event, activity, and/or routine and optionally a time corresponding to the location. In some implementations, for example, the location data can be generated using a Wi-Fi access point trace and/or a cellular trace. The user may be on user device 102a, which is capable of interacting with signals from the one or more Wi-Fi access points and/or cellular networks. Data collection component 215 may locate the user at least partially based on these interacting signals and generate the location data accordingly, such that event tracker 216 can use the location data to locate the user. As an example, the location data can be based on detecting one or more of those networks and could comprise one or more network names and/or network identifiers corresponding to the networks. Event tracker 216 can use the location data to map the networks to a location corresponding to the user or otherwise utilize information resulting from the interacting signals (e.g., optionally in combination with the spatial-temporal samples).

The semantic characteristics (e.g., characteristics 286) for a record generally represent the semantic characteristics of the instance of the model other than those explicitly shown in FIG. 2 (e.g., time and location). As indicated above, semantic characteristics can take various forms (e.g., sporadic, routine, inferred explicit) and may be utilized as inputs to tracked features, or may be values thereof.

In some implementations, each instance of an activity is associated with a corresponding instance of an event. Thus, various semantic characteristics of the instance may be leveraged, such as one or more of the time stamp, location, and semantic characteristics. For example, the time stamp may be used as a time stamp of an instance of an activity and a location may be used as a location of an activity. In addition, or instead, at least some semantic characteristics of an activity may be generated based on the semantic characteristics from multiple instances events. For example, a time stamp and a location for an instance of an activity may be generated by aggregating time stamps and/or locations of instances of the events that correspond to the activity.

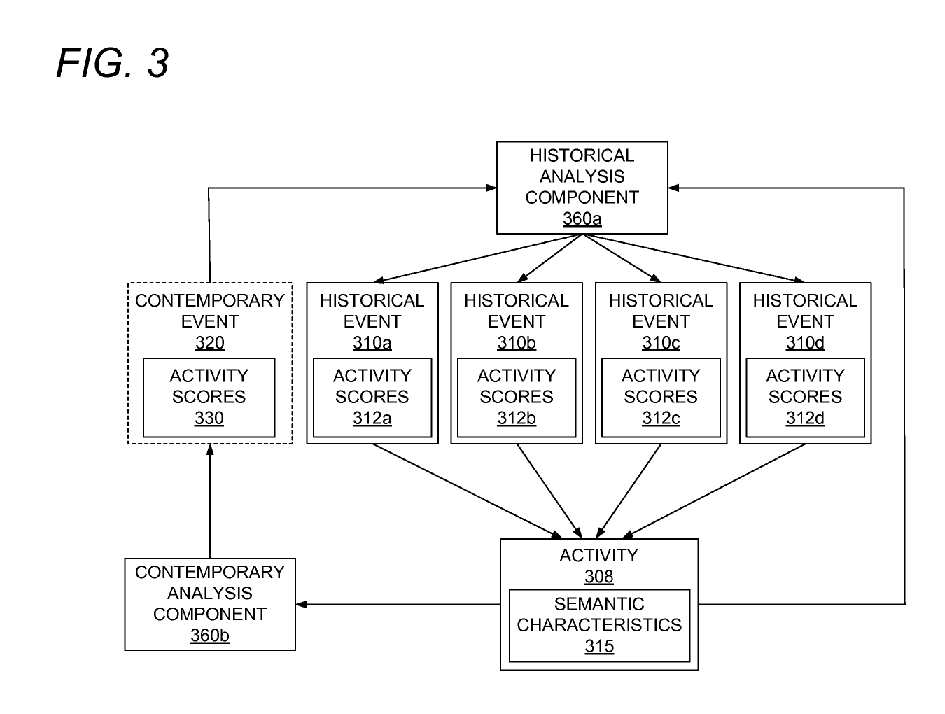

As shown, activity analyzer 260 comprises historical analysis component 260a and contemporary analysis component 260b. Referring to FIG. 3, FIG. 3 shows an exemplary diagram illustrating functionality of activity analyzer 260 of FIG. FIG. 3 shows historical analysis component 360a and contemporary analysis component 360b corresponding respectively to historical analysis component 260a and contemporary analysis component 260b in FIG. 2. Historical analysis component 360a is configured to analyze activity models with respect to historical instances of events, such as historical events 310a, 310b, 310c, and 310d.

In various implementations, historical analysis component 360a is configured to detect and/or identify instances of activities with respect to the historical events. For example, semantic characteristics 286 may be applied to each of activity models 269 to determine which of the activity models, if any correspond to the instance of the event. Exemplary features applied to the activity models will later be described in additional detail. In some implementations, historical analysis component 360a assigns an activity score to each activity model being analyzed with respect to an instance of an event. For example, FIG. 3 shows activity scores 312a, 312b, 312c, and 312d. Each activity score quantifies a level of confidence that a particular activity model corresponds to the instance of the event. An activity score is output by its corresponding activity model and may be generated by applying any of various machine learning algorithms to the tracked features.

The activity scores of an instance of an event can optionally serve as a ranking of activities for that event. Thus, activity scores from multiple activity models may be normalized for relative ranking across models. The scored activity models may represent candidate activities for the instance of the event. As used herein an instance of an activity may be a candidate activity or an identified activity (also referred to herein as a “practiced activity”). An identified activity corresponds to an activity model that activity analyzer 260 determines has likely occurred. Identified activities may be selected from candidate activities. Similar terminology is used for instances of events. In some implementations, activity analyzer 260 designates one or more candidate activities as identified activities for the instance of the event based on the activity scores. For example, a candidate activity may be designated as an identified activity based on its activity score exceeding a threshold value. Each activity model could have a corresponding threshold value for being identified, which may be machine learned for that activity model. In other cases, a single threshold value could be applied to all of the activity score for an instance of an event.

Having identified one or more activities for an event, presentation component 298 may provide personalized services for the user based on the particular activity or activities identified and optionally based on the particular instance of the event. The personalized services may, for example, be based on the semantic characteristics of the event and/or activities.

In further respects, activity analyzer 260 can extract and identify activity instances from multiple-historical events, such as activity 308 shown in FIG. 3 (i.e., a multi-event activity). In doing so, activity analyzer 260 can apply various forms of pattern matching algorithms to the historical instances of the events, including tracked features, activity scores, and the like. As one specific example, for a given activity model, activity analyzer 260 could select each instance of an event that has an identified activity correspond to the activity model. Other selection criteria may be utilized, such as the recency of the time stamp of the event, and/or other semantic characteristics. In some cases, an activity may optionally be identified as being practiced by, or routine for, the user based on the selected historical event. As one specific example, where the number of selected historical events exceeds a threshold number, the activity may be identified as a practiced activity.

In further respects, semantic characteristics can be extracted for activity models with respect to the user. For example, activity analyzer 260 may analyze patterns of the semantic characteristics of selected historical events. As an example, for a given semantic characteristics, that may or may not be present in all of the historical events, activity analyzer 260 can identify patterns, or routines, using routine models for activities. These patterns based characteristics (i.e., routine characteristics) of activities can be stored in association with the activity model for the user. In particular implementations, that an activity is practiced and/or semantic characteristics (e.g., semantic characteristics 315) thereof may be stored in a corresponding one of activity profiles 245 for a user.

Having identified one or more activities that a user practices, presentation component 298 may provide personalized services for the user based on the particular activity or activities and optionally based on the selected historical events. The personalized services may, for example, be based on the semantic characteristics (e.g., routine characteristics) of the historic events and/or activities.

From the foregoing, it should be appreciated that routine characteristics of users, events, activities, and/or venues can be based on patterns formed by user data and/or data extracted therefrom, such as semantic characteristics. Patterns of detected and/or identified events and/or activities of users may be employed in identifying routine characteristics of users and/or in detecting divergence from the routine characteristics. Further, these patterns may be utilized in identifying new or contemporaneous instances of events and/or activities and reinforcing, or re-evaluating historical events and/or identified activities thereof. As an example, contemporary analysis component 360b in FIG. 3 can utilize semantic characteristics 315 of activity 308 as a tracked feature for detecting and identifying new instances of events and/or activities or refining previously identified activities, and/or previously determined activity scores.

FIG. 3 shows contemporary event 320 detected partially based on semantic characteristics of the user associated with an activity model, such as semantic characteristics 315. In some implementations, semantic characteristics 315 may represent predictions of semantic characteristics for the user. An exemplary prediction approach is described below with respect to computing posterior predictive distributions. In some implementations, the semantic characteristics are utilized as inputs to one or more features of an activity model. The semantic characteristics of the activity models can supplement contemporaneously sensed, or real-time values of semantic characteristics (i.e., actual semantic characteristics of a contemporary instance) utilized to determine the user is presently active in an instance of an event and/or activity. A confidence score for a feature may be computed by applying a Dirchlet-multinomial model and computing the posterior predictive distribution of each period histogram using the contemporaneously sensed semantic characteristics and the predicted semantic characteristics (e.g., comparing the two).

These inferences for identification of contemporaneous events (e.g., contemporary event 320) and/or activities may be referred to as online mode, as opposed to the offline mode utilized to infer and identify activities of historical events. However it should be appreciated that these predictions corresponding to semantic characteristics 315 may be made in offline more and compared to non-real-time values of semantic characteristics (i.e., actual semantic characteristics of a historical instance) for identifying activities from historical events. Further, these predictions may be used any time the system quantifies typical behavior of the user.

Activity scores 330 may be generated during online mode based on various activity models. One or more activities may be identified from activity scores 330 similar to what has been described above with respect to historic events. However, it is noted that an activity model could utilize different sets of features for online mode than offline mode.

Having identified one or more contemporary activities of a user, presentation component 298 may provide personalized services for the user based on the particular activity or activities and optionally based on contemporary instance of events. The personalized services may, for example, be based on the semantic characteristics (e.g., routine characteristics) of the contemporary activity, event, and/or historic events and/or activities. By identifying activities in an online mode, personalized services can be provided to the user as activities are occurring to assist the user in performing the activities or otherwise provide time-sensitive information for the user.

It is noted that in some implementations, contemporary event 320 does not correspond to a particular identified event model or event (e.g., one of event models 261). In particular, the instance of an activity can be inferred from the activity models themselves and semantic characteristics associated with the practiced activity. The contemporary event may optionally be incorporated into the historical events and utilized by historical analysis component 360a, as shown (e.g., for offline mode). Thus, certain historical events may not be based on a corresponding event model, or an event model might be later associated with the contemporary event.

As further indicated in FIG. 3, semantic characteristics (e.g., semantic characteristics 315) of activity models aggregated from historical events can optionally provide feedback to historical analysis component 360a to adjust activity scores and identified instances of activities for events. Thus, activity scores for a particular instance of an event may be based on patterns for that activity across multiple events that are conveyed in the semantic characteristics. As an example, a user that typically shops on Friday is more likely to have shopping during an event that occurred on Friday. This pattern may be detectable from multiple historical events, but not from a historical event alone.

Exemplary approaches to pattern detection utilized by routine models for in generating routine characteristics are described below, where each instance of an event or activity has corresponding historical values of tracked features that form patterns. Event tracker 216 and activity analyzer 260 may evaluate the distribution of the values of the tracked features for patterns. In the following example, a tracked feature for an event and/or activity is a time stamp corresponding to an instance of a modeled activity or event. However, it will be appreciated that conceptually, the following can be applied to different types of historical values. Further, certain selection criteria may be may be applied to filter the events and/or activities from which values are provided for pattern detection.

A bag of time-stamps (i.e. values of a given tracked feature), can be denoted as {tₘ}ₘ₌₁^{M}, and mapped to a two-dimensional histogram of hours and days of the week. The two-dimensional histogram can comprise a summation over the instances of the event, such as:

hᵢⱼ=Eₘ₌₁^{M}1[dayOfWeek[tₘ]=i] [symbol] 1[hourOfDay[tₘ]=j].

This histogram can be used to determine derivative histograms. For example, a day of the week histogram may correspond to:

hⱼ=Σᵢhᵢⱼ

An hour of the day histogram may correspond to:

hᵢ=Σⱼhᵢⱼ.

As further examples, one or more histograms may be determined for particular semantic time resolutions in the form of:

h_{iC}=Σ_{jεC}hᵢⱼ.

Any of various semantic time resolutions may be employed, such as weekdays and weekends, or morning, afternoon, and night. An example of the latter is where, C E {morning, afternoon, night}, morning={9, 10, 11}, afternoon={12, 13, 14, 15, 16}, and night={21, 22, 23, 24}.

An additional data structure utilized in representing an event can comprise the number of distinct time stamps in every calendar week that has at least one time stamp therein, which may be represented as:

wᵢ^{j}=∥{m|tₘ is within the i-th j week period}∥

As an example, w₂³ can denote the number of distinct time stamps during the 2^{nd} 3-week period of available time stamps. N^{(j)} may be utilized to denote the number of j-week time stamps available in the tracked data, for example, N⁽³⁾ denotes the number of three week periods available in the time-stamps.

A confidence score may be generated that quantifies a level of certainty, or confidence, that a particular pattern is formed by the historical values in the tracked feature. In the following example, the above principles are applied utilizing Bayesian statistics.

In some implementations, a confidence score can be generated for a corresponding tracked feature that is indexed by a temporal interval of varying resolution. For time stamps, examples, include Tuesday at 9 AM, a weekday morning, and a Wednesday Afternoon. The confidence score may be computed by applying a Dirchlet-multinomial model and computing the posterior predictive distribution of each period histogram. In doing so, a prediction for each bin in a particular histogram may be given by:

$${x}_{i} = \frac{{α}_{0} + {h}_{i}}{{Σ}_{i}^{K} ( {α}_{0} + {h}_{i} )}$$

Where K denotes the number of bins, α₀ is a parameter encoding the strength of prior knowledge, and i*=arg maxᵢ xᵢ. Then, the pattern prediction is the bin of the histogram corresponding to i* and its confidence is given by x_{i*}. As an example, consider a histogram in which morning=3, afternoon=4, and evening=3. Using α₀=10, the pattern prediction is afternoon, and the confidence score is

$$\frac{10 + 4}{( 10 + 3 ) + ( 10 + 4 ) + ( 10 + 3 )} = \frac{14}{40} \approx 0.35 .$$

In accordance with various implementations, more observations of results in an increased confidence score, indicating an increased confidence in the prediction. As an example, consider a histogram in which morning=3000, afternoon=4000, and evening=3000. Using a similar calculation, the confidence score is

$$\frac{4010}{10030} \approx 0.4 .$$

Also in some implementations, a confidence score can be generated for a corresponding tracked feature that is indexed by a period and a number of time stamps. Examples include 1 visit per week, and 3 visits every 2 weeks. Using a Gaussian posterior, a confidence score may be generated for a pattern for every period resolution, denoted j. This may be accomplished by employing the formula:

$$= λ ( \frac{1}{{N}^{( j )}} {Σ}_{i}^{{N}^{( j )}} {w}_{i}^{( j )} ) + ( 1 - λ ) {μ}_{0} , where λ = \frac{{σ}_{0}^{2}}{\frac{{σ}^{2}}{{N}^{( j )}} + {σ}_{0}^{2}} .$$

In the foregoing, σ² is the sample variance, σ₀² and μ₀ are parameters to the formula. A confidence score can be computed by taking a fixed interval around the number of time stamps prediction and computing the cumulative density as:

$${conf}_{j} = P ( \vert x - \vert < a ) = 𝒩 ( x \vert , {\hat{σ}}^{( j )} ) , where {\hat{σ}}^{( j )} = \frac{1}{\frac{{N}^{( j )}}{{σ}^{2}} + \frac{1}{{σ}_{0}^{2}}} .$$

As an example, consider the following observations: w₁⁽¹⁾=10, w₂⁽¹⁾=1, w₃⁽¹⁾=10, w₄⁽¹⁾=0, w₁⁽²⁾=11, and w₂⁽²⁾=10. N⁽¹⁾=4 and N⁽²⁾=2. Using μ₀=1 and σ₀²=10, μ⁽¹⁾=4.075 and conf₁=0.25. Furthermore, μ⁽²⁾=10.31 and conf₂=0.99. In the foregoing example, although fewer times stamps are available for two week periods, the reduced variance in the user signals results in an increased confidence that a pattern exists.

Having determined that a pattern exists, or that the confidence score for a pattern is sufficiently high (e.g. exceeds a threshold value), the system may identify that a routine corresponds to a user and/or whether one or more instances or predicated instances of a routine diverges from or conforms to the routine using one or more of these values.

As an example, the system may determine a level of conformance between a value of the tracked feature of the routine and the pattern. This approach may be employed, for example, by contemporary analysis component 360b in generating activity scores 330, as well as being utilized by other components describes with respect to FIG. 3. In some cases, conformance may be detected so long as the value is not greater than or equal to approximately one standard deviation from the time stamps of the pattern. In some cases, two standard deviations could be employed, or fractions thereof. The standard deviation may be established by mapping a function to the time stamps of the pattern, such as a Gaussian function, or bell curve, as an example.

As a further example, the system may determine that a routine is being practiced by a user (e.g., to determine a user practices an activity or routine characteristics thereof) where one or more of the confidence scores for one or more tracked features exceed a threshold value. In this regard, a routine may be determined as being practiced based on the system identifying one or more patterns in historical values of one or more tracked features.

Thus, the system can not only infer that a user practices an activity, but can infer various patterns that occur when the user practices the activity. As some examples, the system may determine that a certain user typically shops for shoes when shopping, the user is typically with their family when they go shopping, the user typically shops on Wednesdays, the user typically shops at clothing stores on Wednesdays and grocery stores on Sundays. This type of information can be leveraged both for detecting instances of activities and for personalizing service content to the user.

Some exemplary constituents of an activity model are shown with respect to activity models 269, which can also include those that have been described above. As shown, each activity may have an activity identifier (e.g, activity ID 270) that uniquely identifies the activity.

Also shown is sub-activity IDs (e.g, sub-activity IDs 275). Sub-activity IDs comprise activity IDs for activities that are sub-activities of the activity. In particular, an activity model may comprises one or more sub-activity models. A sub-activity is more granular than an activity and provides a deeper understanding of the behavior of the user. In some cases, a sub-activity may comprise additional features or signals that may be utilized to identify the sub-activity. For example, assume an activity model represents a user going to a restaurant. A sub-activity could be the user only going to the same restaurant, going to a restaurant with the family, going to a restaurant on a date, going to an Italian restaurant, going to a restaurant for work, going to a restaurant to celebrate, or going to a restaurant for lunch. It will be appreciated that multiple instances of sub-activities can be detected for a single instance of an activity.

Additional features and/or conditions may be needed to detect these activities. For example, features for the Italian restaurant example above could correspond to identifying a venue visit associated with a venue having an Italian restaurant category, detecting reservations for an Italian restaurant made by the user, identifying Italian cuisine on a restaurant bill associated with the activity, searches proximate to the activity related to Italian cuisine, and more.

Further shown are complementary activities or events (e.g, complementary activities 274). Detected and/or identified complementary activities can be utilized as tracked features for an activity model. Complementary activities may have respective activity models and activity IDs. A complementary activity for an activity model represents an activity closely associated with the activity model, such that detecting a complementary activity strongly indicates an instance of the primary activity. One or more complementary activities may be predefined for each activity and/or sub-activity thereof, and can be utilized to disambiguate activities. In some implementations, the set of complementary activities associated with a primary activity model are unique to that activity model.

An example of a complementary activity is a user interaction with a specific application or application category. For example, for an activity model corresponding to the user going to a restaurant a complementary activity could correspond to the user launching a restaurant review app or a restaurant reservation app. As another example, a complementary activity could represent the user searching for particular topics or categories on the web, viewing particular web sites or types of websites, or other modeled browsing activity. Continuing with the restaurant example, a complementary activity could correspond to the user searching for Italian food or restaurants. Further examples include the user texting, emailing, or otherwise communicating to a contact content that corresponds to a restaurant and/or particular type of restaurant, dinner, appetite, food.

Complementary activities for an activity model may optionally be selected for analysis based on comparing time stamps of the complementary activities to a time stamp of an instance of the activity model being evaluated. For example, more remote instances of activities to the primary instance might less likely be complementary to the primary instance. However, in some cases, semantic characteristics of an instance of a complimentary activity might indicate a time based association. For example, the user could send a text that says “dinner Friday?” or “I can't wait until that new restaurant on 5^{th} street opens in January.”

Some complementary activities may be prep-activities (e.g., prep-activities 274a) that occur prior to a primary activity. As an example, prep-activity could model a user making a reservation that corresponds to an activity model. As examples, a user may book a table prior to visiting a restaurant or may buy a movie ticket prior to watching a movie. Prior to a shopping activity, the user might go over a list of deals, search for coupons, or check a shopping list.

Other types of complementary activities include post-activities (e.g., post-activities 274b) that occur after a primary activity. As an example, post-activity could model a user writing a review that corresponds to an activity model. As examples, a user may talk about a restaurant on Facebook, or Yelp after eating there. As another example, a user might post a movie review after watching a movie, or send a text to a contact mentioning the movie.

Also shown is a participants characteristic (e.g, participants characteristic 272). A participants characteristic represents a routine characteristic corresponding to a detected pattern or routine of one or more other users that are typically associated with the user for instances of the activity mode. It will be appreciated that a participants characteristic can be analyzed, for example, with respect to particular days, and/or weeks of a month. For example, a user may typically shop with her kids on Fridays and may shop alone on Mondays.

A participants characteristic is a type of affinity characteristic, which are based on affinity patterns of a user. By utilizing an affinity characteristic, activity analyzer 266 can assess activity models with respect to conformance with typical participants/attendees of the activity. As an example, an affinity characteristic that can contribute conformance may be based, in part, on affinities between the user and one or more attendees of the activity that correspond to contact profiles, or users, being tracked as part of one or more affinity-based routine models of the user (e.g., a pattern of user interaction with a contact profile modeled by a routine model).

In some implementations, activity analyzer 266 accesses a list of the attendees of a calendar event associated with an instance of an activity, or users otherwise known to be associated with the instances. Activity analyzer 266 may generate affinity scores with respect to the list of attendees with respect to the activity model. One or more of the affinity scores may be used by activity analyzer 266 to generate a feature score for the affinity characteristic. As an example, the one or more affinity scores may be an aggregate affinity score for the list of attendees, or an affinity score may be provided for each attendee, by way of example. Affinity scores correspond to a quantified level of association between a user and one or more other users, or contacts, with respect to an activity. In particular, the attendees may be mapped to one or more contact entries that are being tracked by event tracker 216 with respect to the user. In some cases, the contact entries correspond to entries in the user's contact book, such as the user's mobile contacts, and/or email contacts. Each contact entry may include a corresponding name, and one or more street addresses, e-mail addresses, phone numbers, and the like. In some cases, the list of attendees may comprise the contact entries of the attendees or and/or indicators thereof, for example, where the attendees for activities are generated from a contact book shared with activity analyzer 266. In other cases, activity analyzer 266 may infer the contacts from information provided in the list of attendees, such as names, e-mail addresses, and the like.

An affinity between a user and an attendee can be based on various tracked interactions between the user and the contact corresponding to the attendee. Examples of interactions that can increase the affinity include e-mails to and or from the contact, text messages to and/or from the contact, phone calls to and/or from the contact, other sensor data associating the user with the contact, and quantities of any of the forgoing. A confidence score for a particular attendee may be based on detecting clusters of the interactions during time periods when the activity routinely occurs for the user. For example, an event model could track these interactions and had time stamps used to match interaction patterns with attendees to patterns of instances of particular activities.

The affinity can be based on other instances of events, meetings, and/or activities where the user and the contact were both detected as attendees. Further, text messages, phone calls, emails, and the like associated with the user and/or instances of activities may increase the affinity. For example if a contact typically calls, texts, or otherwise communicates with the user during an activity, an affinity may increase for an activity model. As other examples, affinity may be based on locations of the attendees (e.g., locations that are tracked features of events of other users). As with each semantic characteristic described herein, the score for an affinity characteristic may be discounted based on the recency of the detected interactions or stale interactions may be discarded or remain unused. Thus, more proximate interactions are more likely to increase affinity than less proximate interactions.

A participants or affinity characteristic may further be with respect to relationship categories or tags of participants or attendees. Examples include mother, father, sister, brother, cousin, friend, co-worker, family member, wife, husband, significant other, and more. For example, an activity (e.g., a sub activity) may require the presence of at least one family member or a particular family member (e.g., a “family time” activity). Such relationship based characteristics are often found in contact books of users and may in general be explicit or inferred by the system.

A feature score for an affinity-based feature can be generated based on the one or more affinity scores. It will be appreciated that various approaches may be employed. In general, higher affinity scores indicate the attendees or participants are less unusual for the user in the activity. Other factors may include the number of attendees or participants having an affinity score that exceeds a threshold value of having low affinity to the user. However, in some cases, the affinity scores may be aggregated to generate a feature score, for example, as an average of the affinity scores.

Further shown in FIG. 2 are local categories (e.g, local categories 273). Each activity model may be assigned at least one local category. For example, local categories may be preconfigured for each activity model as a property of the model. Local categories may be utilized to map locations of instance of events to activities. For example, location 284 may be mapped to a local category associated with one or more activity models. In some implementations, the local category is utilized as a feature or indicator that contributes to the activity score of an activity model. In other cases, activity models for an instance of an event are selected from activity models matching the local category.

An example of a local category is a movie theater. Activity models that could be mapped to the movie theater category include working, watching a movie, family time, on a date, picking someone up, or dropping someone off. Another example, of a local category is swimming pool. Activity models that could be mapped to the swimming pool category include swimming, lounging, picking someone up, and dropping someone off.

In some cases, a location of an instance of an event may be mapped to more than one local category. Furthermore, in some implementations, a local category is associated with a venue that corresponds to the location. For example, the location may be a venue ID or be mapped to one or more venue IDs (e.g., nearby venues) associated with the local category. This information may be included in venue profiles 224. Further examples of local categories are venue chains (e.g., a particular venue chain-store), a venue category, or a utility category, such as a coffee shop or park. In some cases, at least some of these local categories are extracted from yellow pages.

In some implementations, determining a local category comprises identifying a visited venue and utilizing a local category assigned to the visited venue. Activity models may then be analyzed that match the local category. As a specific example, an event model could represent a user visiting a venue. Event tracker 216 can utilize the event model to infer venue visits by users to one or more venues using any combination of the information available in system 200. In particular, event tracker 216 can apply any combination of the semantic information to infer which particular venue is visited by a user. Such semantic information comprises any of the various characteristics of users and venues described herein, such as characteristics 286.

In various implementations, event tracker 216 employs location data associated with a user (e.g., any of the users corresponding to user accounts 222), such as spatial-temporal data, in order to infer venue visits for the user. Event tracker 216 can determine location 284 (e.g., geo-location) of the user using the location data, as described above.

Event tracker 216 can generate a set of candidate venues based on proximity between the determined location (e.g., geo-location) of the user and the candidate venues. The candidate venues may be selected from the venues corresponding to venue profiles 224 based on the proximity. In some implementations, event tracker 216 selects each venue located within a given radius or region of the user location as a candidate venue. The radius used can be determined based upon the accuracy of the location data, such that event tracker 216 uses a larger radius or region for less accurate location data. The accuracy of the location data may be determined, for example, based on the source or sources of the data and/or from the location data itself (e.g., based on values thereof). For example, event tracker 216 may employ a smaller radius for location data extracted from or using a GPS receiver than for location data based on network tracing absent data from a GPS receiver.

Additionally, one or more venues may be included in the set of candidate venues by using one or more other approaches to candidate venue identification. For example, such a candidate venue may not necessarily have a venue profile in venue profiles 224 associated with a specific location, but instead may be more generic or categorical. Examples include a private residence, a beach, a park, or an office, although other types of venue categories can be employed. These venues may be referred to herein as categorical venues and are distinguished from specific venues. Including one or more categorical venues, in addition to or instead of one or more specific venues offers several potential advantages.

Event tracker 216 can subsequently use semantic information to infer which of the candidate venues is visited by the user. For example, the inference can be based upon any combination of characteristics (e.g., characteristics 286) of one or more users or venues, such as the user and candidate venues.

In some implementations, event tracker 216 determines whether the user has visited any venue (e.g., regardless of the particular venue that is visited). Such a determination may occur before or after selecting the candidate venues. In some cases, event tracker 216 first searches for at least one candidate venue as part of determining whether the user has visited any venue. Where no candidate venues are selected (e.g., the set of candidate venues is empty), event tracker 216 can determine that no venue visit has have occurred. However, if at least one candidate venue is selected, event tracker 216 may proceed with further analysis. For example, event tracker 216 may perform an analysis capable of distinguish between whether a venue had been visited or merely passed or walked by.

The determination can be based on one or more locations of the user indicated in the location data (e.g., the geo-location) and the duration the user was at or near the location. This can include using cluster analysis of spatial-temporal samples (e.g., a location sample and associated time stamp). This can further include considering one or more prior venue visits being tracked by the system for the user. As an example, the system may consider the previous venue visit being tracked for the user. Where the system is determining whether there was a current venue visit after determining the user has at least one subsequent venue visit, the system can additionally or instead consider subsequent venue visits tracked for the user. As an example, the system may consider the following venue visit being tracked for the user.

Prior and/or subsequent venue visits can be used, for example, by event tracker 216, to attempt to map the venue visit being analyzed to a routine of the user. Where event tracker 216 is able to map the venue visit to the routine, it is more likely that a venue visit has occurred. As an example, the user may have a routine of going from home to work every weekday. Leaving home may be one event of the routine, arriving at work may be another event of the routine, and stopping by a coffee shop one the way to work may be yet another event of the routine, as indicated in user tracking data. Event tracker 216 may map the venue visit to the stop by the coffee shop based on the geo-location of the previous venue visit being tracked corresponding to the user's home, and optionally based on a following venue visit being tracked corresponding to the user's work. Event tracker 216 may further utilize other information, such as comparing time stamps of the geo-locations to times the user typically performs the visits (i.e., routine characteristics of the user) and/or known activities of the user.

By mapping the venue visit to a routine of the user, event tracker 216 can have increased confidence in inferring that a venue visit has occurred. For example, a venue visit may be inferred in situations that otherwise might not be possible using location data alone due to various limitations in location data. For example, the location data may have a limited number of location samples, such as a single location sample for a geo-region, may have a low level of accuracy, or may otherwise lead to inconsistent or inconclusive results when analyzed. Thus, cluster analysis may not conclusively identify a venue visit, but by analyzing the semantic information (e.g., historical activities of the user), event tracker 216 can still accurately infer the visit likely occurred.

Event tracker 216 can further rank candidate venues by a likelihood that the user has visited a particular candidate venue. It should be appreciated that as used herein, terms such as confidence and likelihood can be quantified as a score, and any determinations or inferences made based on confidence or likelihood can be based on whether the score exceeds a threshold value. Thus, for example, the likelihood with respect to each candidate venue may be quantified using a corresponding confidence score. In implementations where event tracker 216 determines whether the user has visited any venue, the ranking could potentially only be performed where event tracker 216 first determines that a venue visit has occurred or is occurring, thereby saving processing power. As another example, the ranking may occur, but a visited venue may only be selected where it is determined that the user has visited any venue.

It will therefore be appreciated that determining whether any venue visit has occurred can be independent or dependent upon the rankings and/or confidence scores depending on the approach employed. An example where the determination is dependent upon or based on the rankings and/or confidence scores is where none of the venue visits are sufficiently likely to have occurred (e.g., none of the confidence scores exceed a threshold value) such that it is inferred that no venue is visited. An example that is independent of the rankings and/or confidence scores is has been described above, although that determination may be made prior to or after generating the rankings.

Event tracker 216 can base the ranking of the candidate venues on semantic information, such as characteristics 286. For example, one or more semantic signals can be used, which are extracted from user and/or venue data collected by the system. The semantic signals can include one or more characteristics of the venue, the users, and/or one or more other users. This can include whether activities are typically performed at the visited venue of the user. The characteristics can be any combination of explicit and/or inferred characteristics of venues and/or users. Further, the characteristics can be any combination of sporadic and/or routine characteristics. The semantic signals may be fed into a probabilistic model, which generates a confidence score from the semantic signals.

In various implementations, event tracker 216 selects a visited venue for a visit based on the ranking of the candidate venues. For example, the highest ranked venue (e.g., having the highest confidence score) may be selected as the visited venue. The visited venue can be selected at any suitable time, such as after the candidate venues are initially ranked, and/or after the rankings are revised at least one time. Further, it is noted that the selected visited venue can optionally be revised, or reselected, for example, after subsequent re-ranking, analysis, and/or optimization of the venue visits.

From the forgoing it should be understand that, in some cases, activity analyzer 260 may optionally analyze activities for instances of an event based on event tracker 216 determining that the event likely occurred. Further, activity analyzer 260 may analyze activities for an instance of an event based on selection of a venue for a venue visit. In some cases, event instances may be tied to a location however, by abstracting activities from the events, the instances of activities are not bound by the locations.

Based on the detecting and/or identification of activities of users, as well as patterns formed by instances of the activities, content (e.g. content 399) may be presented to the user using presentation component 298. The content may be presented, for example, on any combination of user devices 102a and 102b through 102n. In this capacity, presentation component 298 may employ any of the various data collected from data collection component 215, such as that associated with user profiles 222 (e.g., activity profiles 245 for a user) in tracking data, as well as other data. Presentation component 298 can determine when and/or how content is presented to a user based on the information. Presentation component 298 can further determine what content is provided to the user based on the information. In some embodiments, presentation component 298 comprises one or more applications or services operating on a computing device (such as device 700 described in FIG. 7 including a user device, such as a mobile computing device) or in the cloud.

Determinations made by presentation component 298 with respect to content to be presented based on activity profiles of users may optionally be based on contextual information corresponding to the instances of activities. In some implementations, activity analyzer 260 may generate the contextual information, which may be provided to presentation component 298. Contextual information generally corresponds to information that provides context to instances of activities.

Activity analyzer 260 may generate contextual information utilizing interpretive data to infer or otherwise determine the contextual information, at least partially from user data associated with the user. For example, contextual information could correspond to loyalty metrics that indicate a user's loyally with respect to values of tracked features of activity models. Loyalty metrics may be determined by analyzing values of tracked features in historic events (e.g., by historical analysis component 360a in FIG. 3). In some cases, a loyalty metric may quantify a level of variance on the values of a tracked feature for an activity model. As an example, based on the locations of historical events, historical analysis component 360a could calculate a loyalty score for the location. Low variance in the loyalty score indicates that the user typically participates in the activity at a limited number of locations. High variance in the loyalty score indicates that the user typically participates in the activity at many possible locations.

Loyalty scores can be calculated for any of various tracked features and/or combinations thereof. Furthermore, loyalty scores could be calculated for sub-activates, as well as activities. Presentation component 298 can present content to the user based on the loyalty scores. For example, where a location-based loyalty score exceeds a threshold value, presentation component 298 may recommend content corresponding to a limited set of locations (e.g., venues). For example, where the activity model represents shopping, the user may be presented with coupons from the top five stores the user frequents. As another example, where the activity model represents eating at a restaurant, the system may recommend to book a reservation from a restaurant selected from the top five restaurants frequented by the user.

Loyalty scores are personalized to the behavior of users. For example, while one user loves to try new food and eats at a different restaurant every Friday night, another user may typically go to one of the same five restaurants. By determining the loyalty of the users to these tracked features, the system can provide relevant content to user devices without wasting resources of the system. As an example, the user above would likely not be receptive to a recommended restaurant outside of the set of five restaurants, thereby wasting the system resources. However, a recommendation for one of the five restaurants (e.g., a suggestion from the closed set) is significantly more likely to be relevant to this user. In contrast, the other user may be more open to suggestions. It is noted however, that this user may not have loyalty to a particular venue, but might instead show high loyalty to one or more venue categories. As an example, the user may frequent Chinese and Italian restaurants, but never eat at Seafood restaurants. Thus, the venue category could serve as selection criteria for content.

From the foregoing it can be seen that loyalties may be feature dependent. Loyalties may also be temporally localized. For example, the user above might typically go to the same five restaurants of Fridays, but shows higher variance in locations, or venues on Mondays. Additionally, loyalties could also be activity dependent and/or sub-activity dependent. As an example the user above might typically go to the same five restaurants during Family Time, but otherwise shows high variance in dining choices. As another example, one user may workout in many different locations, whereas another may workout at a few very specific places. A recommendation may be selected from that the few places identified in the values of the tracked feature. For example, the system may recommend the user work out in a particular gym when it's raining or a walk in the park otherwise.

Any or all of these loyalties may be detected for the purpose of providing content to the user. Further, it will be appreciated that loyalties may serve as a tracked feature for activity model and/or sub activity model detection. For example, high loyalty for an activity model for a user coupled with an atypical characteristic of a candidate activity means the activity is less likely to have occurred. In contrast, had the activity model had a low loyalty for the user, the atypical characteristic is less definitive in the identification of the activity.

Presentation component 298 can present content to the user comprising summaries of an activity and locations where the activity was performed. As an example, the locations of the events associated with the activity can be aggregated over the course of a designated period of time such as a week. At the end of the week, the system can provide the user with a summary of locations and activities performed at those locations. For example, a user might be presented with a list of locations where the user worked out over the week, along with the number of times the user worked out over the week.

Other examples of contextual information are confidence scores, variance scores, activity scores, features scores, and other information generated in identifying activities of users. In some cases, presentation component 298 may provide content to a user based on an identified activity and/or contextual information corresponding to the activity. For example, if contextual information indicates the user is on vacation (the activity) in Scotland (the sub-activity), the content provided to the user may provide information about the country, leisure activities available in the area, and the like. This content would not be presented, for example, if the contextual information indicated the user was in Canada, or at work.

Using embodiments of the invention it may be determined that a particular user plays golf (activity) every Tuesday evening as a routine activity. Upon determining that a user missed (or is missing, or will miss) her golf game and has thus diverged (or will diverge) from her routine, content may be generated and presented to the user including one or more of (a) a suggestion for scheduling a tee time at a future time, based on the user's schedule, user routine information, information from sources associated with the golf course (such as a website for the golf course), and/or other user information such as calendar information; (b) a prompt asking the user if the user would like make up the missed golf game (missed instance of an event) and/or if the user would like to automatically schedule a game at a future time; (c) additional information that may be relevant to missed golf game or make-up game based on the contextual information, such as green fees on the dates and times of the potential make-up game.

In addition, or instead, presentation component 298 may refrain from presenting content to the user based on an identified activity and/or contextual information corresponding to the activity. For example, content may be sometimes be presented based activity analyzer 260 determining a user practices an activity, which may not be presented based on detecting a divergence between the user and the routine activity. The content may have otherwise been presented absent the identification of the divergence, but is no longer relevant, and thus not presented. For example, presentation component 298 may typically present the content to the user based on an indication that the user practices the activity.

Where presentation component 298 refrains from presenting the content to a user, processing, power, and other resources related to the presentation of the content are conserved. For example, generating content may utilize network bandwidth, processing power, and energy.

Presentation component 298 can further present content to the user based on one or more recommended actions (e.g., recommended actions 271) associated with the activity (or sub-activity thereof). For example, activity analyzer 260 may provide this information to presentation component 298 for the presentation of content based on an identified activity. In some implementations, each activity is preconfigured with a set of recommended actions for the activity. Further, sub-activities may have specific recommended actions, in addition to the recommended actions for its associated activity. As an example, a user may be presented with their shopping list for a shopping activity and may be presented with a coupon for groceries for a shopping for groceries sub-activity, or an offer to post that the user is shopping for shoes on a social media website for a shopping for shoes sub-activity. In some cases, the recommended actions are selected from a closed set assigned the activity, which may be updated over time.

Activity analyzer 260 can selects the one or more recommended actions for presentation component 298 in the presenting of the content to the user. A recommended action corresponds to data that presentation component 298 can utilize in determining various aspects of the presenting of content to the user. A recommended action may correspond to one or more courses of action for responding to the identification of an activity or otherwise for presenting content for an identified activity.

A recommended action may specify or designate one or more content, one or more static and/or dynamic content fields (e.g. in a content card), one or more content cards, a time, a place or location, a screen or menu, an environment, a mode or manner of user interaction, or other factors that may be incorporated into conditions or instructions with respect to an action. Presentation component 298 may choose or select to follow one or more conditions and/or instructions associated with or corresponding to a recommended action for presenting content to the user.

As examples, a recommended action may indicate to presentation component 298 (or another application or service), and/or be utilized by presentation component 298 to determine, any combination of when to present content to a user (e.g. using a specified time or time range), how to present content to the user, what content to present to the user, when to modify, generate, or select content to be presented to the user, when to refrain from presenting content to the user, when to seek user feedback with respect to content, and many more.

In some embodiments, recommended actions may correspond to one or more conditions, which may be assessed based on sensor(s) on a user device associated with the user, via user history, patterns or routines (e.g. the user drives to work every day between 8:00 and 8:30 AM), other user information (such as online activity of a user, user communication information including missed communications, urgency or staleness of the content (e.g. the content should be presented to the user in the morning, but is no longer relevant after 10 AM), the particular user routine that is diverged from, and/or contextual information corresponding to the out of routine event. For example, where the user is likely driving a car between 8:00 and 8:30 AM, content recommended to be presented to the user during this time may be audibly presented to the user while the user is driving. As another example, content regarding a suggestion that the user make up a missed call, such as where the user calls someone (e.g., his mom) every Sunday, but did not call that person last Sunday, may be presented when the user accesses his phone app on his mobile device. The content may be presented as a pop-up notification, highlighted message, an icon or symbol in a notifications menu, a text, email, other communication or similar means. (For example, upon selecting the phone app to make a call, a message is displayed notifying the user that he did not call his mom on Sunday and asking the user if he wishes to call his mom now.) Similarly, in another example, upon accessing an email application, the user is prompted to reply to an email that the user has not yet replied to, but based on the user's history the user always replies quickly to emails from that contact (e.g. an email from the user's boss). Alternatively, upon picking up the mobile device and without accessing the email application, the user is presented with content that includes a reminder to reply to the email.

Where a recommended action is with respect to one or more content templates, or content cards, the recommended action may specify one or more content cards. For example, a recommended action may be to present one or more content cards to the user, refrain from presenting one or more content cards to a user, or when to present one or more content cards to the user. Furthermore, the recommended action may specify one or more dynamic and/or static content fields with respect to an action associated with content of the fields.

As described above, in some implementations, presentation component 298 can follow one or more recommended actions provided by event tracker 216. In some cases, presentation component 298 may determine whether to follow one or more of the recommended actions. As an example, a recommended action could be to request information from the user. Presentation component 298 may request the information from the user based on the recommended action. Presentation component 298, or another application, or service running on a user device, may determine or select, to follow one or more recommended actions and may determine or select to ignore, or not follow, one or more other recommended actions. For example, one or more recommended actions may be ignored, or not followed, based on one or more criteria, such as, the presentation component already having access to information, determining that the user is away from the device or is unlikely to respond to a recommended action, determining that the recommended action no longer applies or is no longer relevant, presentation component 298 having another suitable, or preferred action, and/or other determinations, or inferences, which are based on user data (e.g. user device data) and/or interpretive data.

Furthermore, in some implementations, presentation component 298 may select to modify one or more recommended actions and to follow one or more of the modified recommended actions. In addition, or instead, presentation component 298 may select or generate one or more actions for presenting content to the user based on a divergence without regard to a recommended action. These actions and recommended actions may be determined in similar or different manners from one another, and may consider similar information.

In some cases, instances of presentation component 298 are incorporated into one or more services (e.g. applications, processes, programs, threads), which may be running on a user device, and/or a different system than any combination of the various constituents of system 200. As an example, one or more services may receive any combination of information generated and/or stored by system 200.

Examples include one or more confidence scores, contextual information, recommended actions, tracked variable variance scores, and more. A service could be running on a user device and may receive such information from a server. As another example, the service could be running on a server in a different system than servers providing such information. As a further example, the information could be received from one or more other services running on the same device (e.g. a user device) as the service. For example, any to all of the various components of FIG. 2 could be incorporated into the same device, which in some cases may be beneficial for security, privacy and/or other reasons.

In some cases, any to all of the information may be pushed to the service from a server, for example, based on a subscription to the information. As another option any to all of the information could be queried for by the service. As an example, the information could be stored in one or more entries in storage 220 for use by presentation component 298.

Thus, it will be appreciated that in some cases, activity analyzer 260 and/or other constituents of system 200 may be provided to applications or services as a cloud service. In this regard, applications on user devices may optionally incorporate an application programming interface (API) for communicating with the cloud service and for providing at least some functionality of presentation component 298. In this way, a common framework may be provided to applications for tailoring content to users based on divergences from their routines.

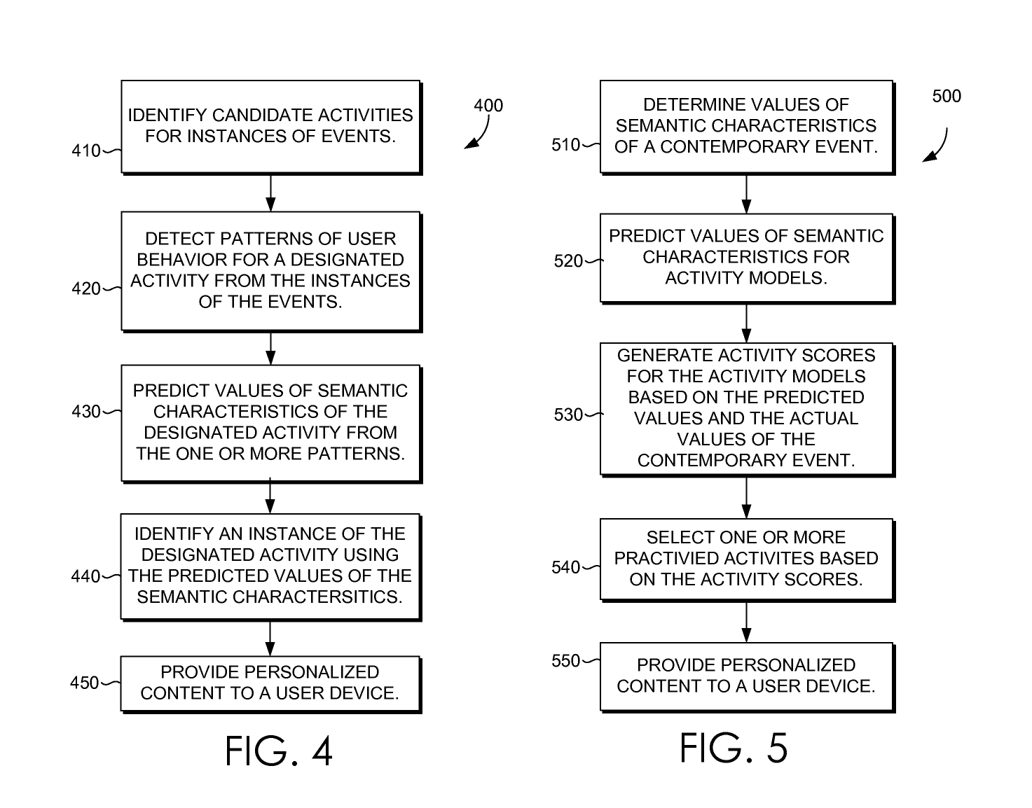

Referring now to FIG. 4, a flow diagram is provided showing an embodiment of a method 400 for detecting activities of users. Each block of method 400 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 410, method 400 includes identifying candidate activities for instances of events. For example, event tracker 216 can detect instances of events of a user (e.g., historical events 310a, 310b, 310c, and 310d) based at least in part on sensor data and activity analyzer 260 can identify candidate activities (e.g., corresponding to activity scores 312a, 312b, 312c, and 312d) for each of the instances of the events.

At block 420, method 400 includes detecting patterns of user behavior for a designated activity from the instances of the events. For example, activity analyzer 260 can detect patterns of user behavior of the user using routine models corresponding to a designated activity (e.g., an activity model corresponding to activity 308) of the candidate activities from the instances of events.

At block 430, method 400 includes predicting values of semantic characteristics of the designated activity from the one or more patterns. For example, activity analyzer 260 can predict values of semantic characteristics (e.g., semantics characteristics 315) of the designated activity (e.g., an activity model corresponding to activity 308) from the one or more patterns of user behavior.

At block 440, method 400 includes identify an instance of the designated activity using the predicted values of the semantic characteristics. For example, activity analyzer 260 can identify an instance of the designated activity (e.g., corresponding to one of activity 308, historical events 310a, 310b, 310c, and 310d, or contemporary event 320) as a practiced activity using the predicted values of the semantic characteristics in an activity model that represents the designated activity.

At block 440, method 400 includes providing personalized content to a user device. For example, presentation component 298 can provide personalized content to a user device (e.g., user device 102a) associated with the user based on the identified practiced activity

Referring now to FIG. 5, a flow diagram is provided showing one embodiment of a method 500 for detecting activities of users. At block 510, method 500 includes determining values of semantic characteristics of a contemporary event. For example, activity analyzer 260 can determine real-time values of semantic characteristics of a user corresponding to a contemporary event (e.g., contemporary event 320) from one or more sensors configured to provide sensor data.

At block 520, method 500 includes predicting values of semantic characteristics for activity models. For example, activity analyzer 260 can predict, for each activity model of a plurality of activity models (e.g., activity models 269), values of semantic characteristics of the activity model based on one or more patterns of user behavior extracted from historical instances of events (e.g., historical events 310a, 310b, 310c, and 310d).

At block 530, method 500 includes generating activity scores for the activity models based on the predicted values and the values of the contemporary event. For example, activity analyzer 260 can generate activity scores (e.g., activity scores 330) for the plurality of activity models based on a comparison between the predicted values of the semantic characteristics and the real-time values of the semantic characteristics.

At block 540, method 500 includes selecting one or more practiced activities based on the activity scores. For example, activity analyzer 260 can select one or more practiced activities (e.g., one or more of activity models 269) of the user from the plurality of activity models based on the activity scores.

At block 550, method 500 includes providing personalized service content to a user device. For example, presentation component 298 can provide personalized content to a user device (e.g., user device 102a) associated with the user based on the at least one of the one or more selected practiced activities.

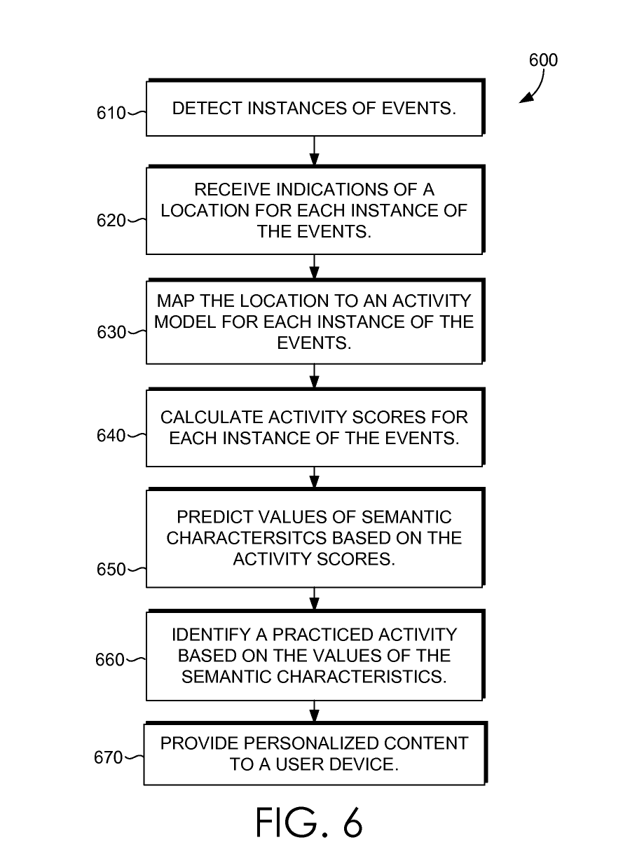

Referring now to FIG. 6, a flow diagram is provided showing one embodiment of a method 600 for detecting activities of users. At block 610, method 600 includes detecting instances of events. For example, event tracker 216 can detect instances of events (e.g., historical events 310a, 310b, 310c, and 310d) of a user based at least in part on sensor data from one or more sensors.

At block 620, method 600 includes receiving indications of a location for each instance of the events. For example, event tracker 216 can receive an indication of a location (e.g., location 284) associated with a user, the location determined based at least in part on the sensor data for each instance of the events.

At block 630, method 600 includes mapping the location to an activity model for each instance of the events. For example, activity analyzer 260 can map the location to one or more activity models (e.g., activity models 269 mapped using local categories), the one or more activity models being candidate actives for the instance of the events for each instance of the events.

At block 640, method 600 includes calculating activity scores for each instance of the events. For example, activity analyzer 260 can calculate activity scores (e.g., activity scores 312a, 312b, 312c, and 312d) for each candidate activity of the candidate activities, each activity score quantifying a level of confidence that the instance of the events corresponds to the candidate activity for each instance of the events.

At block 650, method 600 includes predicting values of semantic characteristics based on the activity scores. For example, activity analyzer 260 can predict values of semantic characteristics (e.g., semantic characteristics 315) of a designated activity (e.g., an activity model correspond to activity 308) of the candidate activities from one or more patterns of user behavior extracted from the instances of the events based on the activity scores.

At block 660, method 600 includes identifying a practiced activity based on the values of the semantic characteristics. For example, activity analyzer 260 can identify an instance of the designated activity (e.g., corresponding to one of activity 308, historical events 310a, 310b, 310c, and 310d, or contemporary event 320) as a practiced activity using the predicted values of the semantic characteristics in an activity model that represents the designated activity.

At block 670, method 600 includes providing personalized service content to a user device. For example, presentation component 298 can provide personalized content to a user device (e.g., user device 102a) associated with the user based on the identified practiced activity.

Having described implementations of the present disclosure, an exemplary operating environment in which embodiments of the present invention may be implemented is described below in order to provide a general context for various aspects of the present disclosure. Referring initially to FIG. 7 in particular, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

As can be understood, implementations of the present disclosure provide for detecting activities using activity models. The present invention has been described in relation to particular embodiments, which are intended in all respects to be illustrative rather than restrictive. Alternative embodiments will become apparent to those of ordinary skill in the art to which the present invention pertains without departing from its scope.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A computer-implemented system comprising:
one or more sensors configured to provide sensor data;
an event tracker configured to detect instances of events of a user based at least in part on the sensor data;
an activity analyzer configured to detect instances of activities of the user based at least in part on the sensor data;
one or more processors; and
one or more computer storage media storing computer-useable instructions that, when used by the one or more processors, cause the one or more processors to perform operations comprising:
identifying, using the activity analyzer, candidate activities for each of the instances of the events;
detecting one or more patterns of user behavior of the user corresponding to a designated activity of the candidate activities from the instances of the events;
predicting values of semantic characteristics of the designated activity from the one or more patterns of user behavior;
identifying, by the activity analyzer, an instance of the designated activity as a practiced activity using the predicted values of the semantic characteristics and actual values of the semantic characteristics of the instance of the designated activity in an activity model that represents the designated activity; and
providing personalized content to a user device associated with the user based on the identified practiced activity.

2. The computer-implemented system of claim 1, wherein the identifying the instance of the designated activity as a practiced activity comprises increasing a level of confidence that the instance of the designated activity is a practiced activity based on detecting an instance of a complementary activity corresponding to the designated activity.

3. The computer-implemented system of claim 1, further comprising calculating a loyalty score of the user based on a variance in historical values of at least one of semantic characteristics, the identifying of the instance of the designated activity as the practiced activity being based on the loyalty score.

4. The computer-implemented system of claim 1, wherein the providing of the personalized content to the user device comprises calculating a loyalty score of the user based on a variance in historical values of at least one of semantic characteristics;
selecting one of the historical values based on the loyalty score exceeding a threshold value; and
selecting the personalized content based on the selected one of the historical values.

5. The computer-implemented system of claim 1, wherein the providing of the personalized content to the user device comprises calculating a loyalty score of the user based on a variance in historical values of at least one of semantic characteristics;
selecting an aberrant value based on the loyalty score being below a threshold value; and
selecting the personalized content based on the selected aberrant value.

6. The computer-implemented system of claim 1, wherein at least one of the semantic characteristics represents one or more participants of the instance of the designated activity.

7. The computer-implemented system of claim 1, wherein each candidate activity corresponds to a respective activity model, each activity model comprises a respective set of tracked features.

8. The computer-implemented system of claim 1, wherein each instance of the instances of the events correspond to an event model comprising a set of tracked features.

9. The computer-implemented system of claim 1, wherein the instance of the designated activity is a contemporary activity and the actual values of the semantic characteristics are real-time values.

10. A computer-implemented method comprising:
determining real-time values of semantic characteristics of a user corresponding to a contemporary event from one or more sensors configured to provide sensor data;
predicting, for each activity model of a plurality of activity models, values of the semantic characteristics of the activity model based on one or more patterns of user behavior extracted from historical instances of events;
generating activity scores for the plurality of activity models based on a comparison between the predicted values of the semantic characteristics and the real-time values of the semantic characteristics, each activity score quantifying a level of confidence that one of the plurality of activity models is a practiced activity;
selecting one or more practiced activities of the user from the plurality of activity models based on the activity scores; and
providing personalized content to a user device associated with the user based on the at least one of the one or more selected practiced activities.

11. The computer-implemented method of claim 10, wherein the identifying the instance of the designated activity as a practiced activity comprises increasing a level of confidence that the instance of the designated activity is a practiced activity based on detecting an instance of a complementary activity corresponding to the designated activity.

12. The computer-implemented method of claim 10, wherein at least one of the plurality of activity models is a sub-activity model of a primary activity model of the plurality of activity models, the primary activity model comprising a set of tracked features and the sub-activity model comprising the set of tracked features and one or more additional track features.

13. The computer-implemented method of claim 10, wherein the activity score of at least one of the plurality of activity models is independent from user location.

14. The computer-implemented method of claim 10, wherein the selecting the one or more practiced activities of the user from the plurality of activity models comprises selecting two or more practiced activities.

15. The computer-implemented method of claim 10, wherein the one or more patterns of user behavior are formed by time stamps assigned to the historical instances of events.

16. The computer-implemented method of claim 10, further comprising identifying the contemporary event from the real-time values of the semantic characteristics;
determining that the contemporary event corresponds to a visit of a venue by the user;
identifying a local category corresponding to the venue based on the determining; and
selecting the plurality of activity models from a larger set of activity models for the generating of the activity scores based on local category.

17. A computer-implemented method comprising:
detecting instances of events of a user based at least in part on sensor data from one or more sensors;
for each instance of the events:
receiving an indication of a location associated with a user, the location determined based at least in part on the sensor data;
mapping the location to one or more activity models, the one or more activity models each being candidate actives for the instance of the events; and
calculating activity scores for each candidate activity of the candidate activities, each activity score quantifying a level of confidence that the instance of the events corresponds to the candidate activity;
predicting values of semantic characteristics of a designated activity of the candidate activities from one or more patterns of user behavior extracted from the instances of the events based on the activity scores;
identifying an instance of the designated activity as a practiced activity using the predicted values of the semantic characteristics and actual values of the semantic characteristics in an activity model that represents the designated activity; and
providing personalized content to a user device associated with the user based on the identified practiced activity.

18. A computer-implemented method of claim 17, wherein the mapping the location to one or more activity models comprises:
identifying a venue visited by the user based on the location;
determining a local category assigned to the location; and
selecting the one or more activity models from a set of activity models based on each of the one or more activity models corresponding to the local category, wherein each activity model in the set of activity models defines one or more local categories for the activity model.

19. A computer-implemented method of claim 17, wherein the instance of the designated activity is a multi-event activity corresponding to multiple-historical events.

20. A computer-implemented method of claim 17, wherein each instance of the events comprises a plurality of candidate activities.
